(19) United States
(12) Patent Application Publication
(10) Pub. No.: US 2010/0244786 A1
(43) Pub. Date: Sep. 30, 2010

(54) ENERGY STORAGE

(75) Inventors: Andreas Gruendl, Starnberg (DE); Bernhard Hoffmann, Starnberg (DE)

Correspondence Address: HISCOCK & BARCLAY, LLP, 2000 HSBC PLAZA, 100 Chestnut Street, ROCHESTER, NY, 14604-2404, US

(73) Assignee: Compact Dynamics GmbH, Starnberg (DE)

(21) Appl. No.: 12/728,743

(22) Filed: Mar. 22, 2010

(30) Foreign Application Priority Data
Mar. 25, 2009 (DE) 102009014908.2

(51) Int. Cl. H02K 7/02; H02K 7/09

(52) U.S. Cl. 322/4; 310/90.5

(57) ABSTRACT

The energy storage has an electrical machine with a rotor and a stator. The stator is separated from the rotor by an air gap and has at least one stator coil which, under operating conditions, interacts with the rotor via a rotating field. In one variant, the rotor surrounds the stator and is adapted to rotate about the stator. Another variant provides for the rotor to surround the stator and to be adapted to rotate within the stator. The rotor is associated with a rotating mass with which it forms a cylindrical body with two end faces and a lateral surface. In the area of at least one of its end to faces—in the installed position of the energy storage, of the bottom end face—the cylindrical body has at least one permanent magnet which corresponds with at least one stationary permanent magnet of identical polarity.

### INTRODUCTION

In the following, an energy storage will be described which is suited, e.g. for the employment in a land vehicle. This may be an energy storage for vehicles which are equipped exclusively or additionally to a combustion machine with at least one electrical machine in the drive train. The described energy storage is, however, also suited for the employment in stationary or mobile applications.

### BACKGROUND

For the purpose of converting at least part of the braking energy during the braking phases of motor vehicles into electrical energy, storing, and reusing it, DE 10 2007 017 342 A1 of Compact Dynamics GmbH described an energy storage which has an electrical machine with a rotor and a stator. The stator is separated from the rotor by an air gap and has at least one stator coil. The rotor is surrounded by the stator. In addition, a rotating mass is associated with the rotor. The rotor with the rotating mass forms a rotating body. If the braking energy is converted electrical energy, this energy may be stored for later situations to enhance or replace the motive power from the combustion machine. In this manner and dependent on the driving situation, approximately 5 percent to 20 percent or more of the motive power from the combustion machine may be replaced or additionally be made available in an enhancing manner for short-term use (e.g. for overtaking operations or for the start-stop operation in road traffic).

### UNDERLYING PROBLEM

Due to the fact that the rotor with the rotating mass rotates at very high speeds (up to 150,000 revolutions per minute and above), the suspension of the rotor with its rotating mass is of major importance for the life of the energy storage. The suspension has to be designed in such a simple manner that it lends itself also for the installation in series vehicles. For the continuous operation in road traffic it has also to be ensured that shocks of several times the gravitational acceleration (up to approx. 50 m/sec²) do not significantly impair the energy storage. Finally, the suspension has to be of an ultra-low-friction construction because otherwise a significant heat generation has to be taken care of, and the storage period of the energy accumulated in the energy storage is significantly shortened.

### BRIEF SUMMARY OF THE SOLUTION

The energy storage has an electrical machine with a rotor and a stator. The stator is separated from the rotor by an air gap and has at least one stator coil which, under operating conditions, interacts with the rotor via a rotating field. In one variant, the rotor surrounds the stator and is adapted to rotate about the stator. Another variant provides for the rotor to surround the stator and to be adapted to rotate within the stator. The rotor is associated with a rotating mass with which it forms a cylindrical body with two end faces and a lateral surface. In the area of at least one of its end faces—in the installed position of the energy storage, e.g. of the bottom end face—the cylindrical body has at least one permanent magnet which corresponds with at least one stationary permanent magnet of identical polarity, in order to keep the cylindrical body at a distance from the stationary permanent magnet. Alternatively or additionally, the cylindrical body has a main axis of inertia, which coincides at least approximately with the axis of rotation, and a non-rotation-symmetrical shape in a sectional plane which extends transversely to the main axis of inertia.

Such an energy storage has two operating modes: A generator mode and a motor mode. In the motor mode or charging operation of the energy storage the stator coils of the energy storage are supplied with current in such a manner that the rotating field which is thereby generated by the stator causes the rotor with its rotating mass to rotate and further accelerates it in its direction of rotation. For this purpose, electrical power is supplied e.g. from an electrical machine which is associated with the drive train of a motor vehicle, which is in the generator mode and decelerates the motor vehicle.

In the generator mode or discharge mode of the energy storage, the conditions are reversed. The stator coils of the energy storage are now supplied with current in such a manner that the rotating field of the stator decelerates the rotor with its rotating mass against its rotating motion, and electrical power output from the energy storage is e.g. supplied to the electrical machine which is associated with drive train of the motor vehicle. This electrical machine is then in the motor mode and drives the motor vehicle—either alone or in combination with the combustion machine of the motor vehicle. In place of the electrical machine which is associated with the drive train of the motor vehicle, another load may be provided with electrical power, in particular, in stationary or mobile applications.

The corresponding permanent magnets of the energy storage in the area of the end faces are arranged in such a manner that they repel each other. This may be achieved, for example, by orienting the permanent magnets transversely or at an acute angle of less than approx. 60° relative to the axis of rotation of the cylindrical body. The permanent magnets which are attached at the cylindrical body are arranged along the circumference of the/of both end face/s and have end faces with a certain polarity (N or S), which are oriented to repelling areas of stationary permanent magnets with identical polarity (N or S). Thereby, the rotating cylindrical body is kept at a contactless distance from the den stationary permanent magnet/s and to the stationary components of the energy storage, which are arranged adjacent to it in the axial direction of the cylindrical body. Thereby, a suspension of the rotating cylindrical body in the direction along its axis of rotation is achieved with virtually no mechanical friction and thus without wear, heat generation, etc.

The rotor which may be described as a cylindrical body may also have a radially oriented asymmetric place. The axis of rotation of the rotor without a fixed radial location by a mechanical bearing is its main axis of inertia. By a suitable mass distribution, the asymmetric place rotates with the rotor upon the rotation of the rotor about the main axis of inertia. This suitable mass distribution of the rotor may be achieved either by a selective removal or a selective addition of material with an otherwise perfectly rotation axis symmetrical body, e.g. a circular cylinder or an annular cylinder. The selective material removal may be effected by asymmetrically distributed holes or recesses in the rotation axis symmetrical body which thereby loses its symmetry relative to its longitudinal centre axis. These holes or recesses may be left empty or filled with a material of a different—lower or higher—density than the material of the rotor. In a similar manner, the shape of the rotation axis symmetrical body may be changed, in that additional material is added along its circumference. In this way, too, the cylindrical body may no longer be symmetric to its longitudinal centre axis.

During the rotation of the cylindrical body, the asymmetric place of the cylindrical body, which faces the air gap, i.e. the area with the greater mass per volume of a body with a circular cylindrical outer contour, attempts to approach the stator. Due to the varying width of the air gap, this induces different magnetic conditions relative to the remaining circumference of the rotor. By a corresponding selective change of the magnetic field of the stator coil this tendency may be counteracted so that the rotor, together with the cylindrical body, attempts to assume or maintain a concentric position relative to the stator without colliding with the stator. To realise this, the stator coil has to be connected with a control circuit.

Specifically, the asymmetric place of the cylindrical body during rotation of the rotor leads to a smaller air gap relative to the stator compared to the remaining lateral surface of the rotor at its respective location. The magnetic rotating field for accelerating or decelerating of the rotor also exerts a normal force (attractive power) orthogonally to the lateral surface of the rotor. With a cylinder symmetrical rotor rotating about its longitudinal centre axis, this normal force would be evenly distributed and approximately compensate itself in its total effect. At the asymmetric place, however, the air gap between rotor and stator is smaller in this (sector-shaped) area. At the same time, the magnetic field is correspondingly stronger with the same current excitation of the stator. At this location, the rotor experiences a stronger attraction towards the stator in an eccentric direction than at the remainder of the lateral surface. From this, a force component results along the imaginary connecting line from the axis of rotation to the asymmetric place. Due to the rotation of the rotor, however, this eccentric force is also compensated in the time average. With a sufficiently high rotational speed of the rotor, the radial displacement of the axis of rotation of the rotor caused by this eccentric force will become sufficiently small compared to the free air gap. With a constant amplitude of the current which produces the rotating field in the stator, the axis of rotation of the rotor describes only small circles about the axis of rotation which is assumed without magnetic force, because of the asymmetry which is caused by the magnetic force resultant. However, it is provided here, to generate a directed radial force mean value by means of a speed synchronous modulation or variation of the amplitude of the stator coil current. This force mean value is to be dimensioned such that the rotor with its axis of rotation which is also its main axis of inertia returns into its central nominal position or remains in it. The (angular) direction of the radial force mean value is determined via the phase position of the modulation. The amount of the force mean value is determined by the amplitude of the modulation. A control circuit which is connected with the stator windings and influences the amplitude of the stator current enables a radial position control of the rotor towards its centred nominal position.

This control operation is performed continuously. Thereby, tilt, tumble, shift movements or the like of the rotor/of the cylindrical body are compensated, and it will swing or tumble during rotation into a central position (again), in which it does not collide with the stator. This approach works both in the generator mode and in the motor mode.

The control circuit is adapted to emboss a current on the stator coils in the motor mode of the energy storage by means of the electrical power consumption. This creates a magnetic rotating field which causes the rotor with its rotating mass to rotate and to (further) accelerate in the direction of rotation. The control circuit is further adapted to supply current in the generator mode to the stator coils of the energy storage in such a manner that the rotating field of the stator decelerates the rotor with its rotating mass against its rotation motion and that subsequently electrical power is output from the storage.

Furthermore, the control circuit has a means for determining the angular position of the rotor. This is required both for the rotary drive and deceleration of the rotor and the phase-correct output of the current amplitude modulation. The latter is required for the selective generation of a radial force which is required for the radial position control. The rotor angular position is to be determined via a sensor which is connected with the control circuit or by the reaction of the rotor on the currents and/or voltages of the stator windings. Specifically, the control circuit necessitates the information on the current radial position (in two dimensions) of the axis of rotation of the rotor for the determination of the actual value of the radial position control. This information may be determined by one or several individual sensors which are to be connected with the control circuit, or also indirectly via the determination of the rotor angle by the control circuit.

The sensors are e.g. Hall sensors, eddy current sensors, light barriers, or the like.

The radial position control works both in the generator mode and in the motor mode. In the neutral mode, i.e. with neither the supply from the, nor the feeding of electrical power into the energy storage, the position control may be performed at a rotating field angle at which the rotor is neither accelerated nor decelerated (i.e. between rotor and rotating field a phase angle of approx. 0° is prevailing).

The control circuit is further adapted to vary the electrical rotating field as a function of the spatial position of the rotor relative to the stator and/or of the spatial position if the asymmetric place of the cylindrical body relative to the stator in such a manner that the centre of gravity of the cylindrical body is urged towards the axis of rotation and the main axis of inertia of the cylindrical body is urged towards its axis of rotation.

The selectively provided asymmetry of the rotor in a sectional plane which extends transversely (orthogonally) to the axis of rotation of the rotor, together with the above explained functionality of the control circuit, allows to omit the separate (electromagnetic) suspension arrangement. The asymmetric configuration of the rotor together with the control circuit makes the contactless electromagnetic suspension of the rotor relative to the stator an integral part of the energy storage. In other words, the asymmetry of the rotor together with the control circuit provides for the suspension without further structural components for the suspension of the rotor.

In known arrangements, the rotor is made as rotation-symmetrical as possible and is statically and dynamically balanced. Contrary to this predominant approach, the energy storage presented herein has a rotor/a cylindrical body with an exactly defined asymmetry whose position relative to the stator, i.e. in particular its angular position in the direction of the rotational movement of the rotor is to be sensed during operation, e.g. by means of the signal from the sensor.

Because of the provided asymmetry, the rotor/cylindrical body presented herein is not balanced “anyway”, and because this unbalance is compensated under operating conditions by the control circuit by means of the corrective current embossed on the stator coil, separate balancing of the rotor/cylindrical body could be omitted.

With the measures presented herein, a suspension of the rotor/of the cylindrical body in the radial and axial direction is obtained, which at least during operation at nominal speed is free from mechanical contact. Because there is virtually no mechanical friction between the rotor and stationary parts during operation, no frictional heat will occur. In addition, an undesired noise generation is prevented. While (electro) magnetic suspension arrangements are known per se, they have previously been realised as (electro) magnetic arrangements with corresponding control, line routing, installation space requirements, etc., which are separate from the electrical machine in a functional, electrical, and spatial aspect. In another known variant, a second coil system with corresponding electrical control, which is independent from the motive power, influences the magnetic field distribution between the otherwise rotation-symmetrical rotor and the stator.

The asymmetric place may be a radially protruding or recessed area relative to the remaining lateral surface on the lateral surface of the cylindrical body with a circumferential angle equal to or less than 180°. The asymmetric place on the lateral surface of the cylindrical body may protrude or be recessed in the radial direction relative to the remaining lateral surface by approx. 5% to approx. 75%, e.g. by 50%, of the radial dimension of the air gap.

It is, however, also possible to create the asymmetry of the rotor by irregularities of a rotor with rotation-symmetrical contours. These may, for example, be recesses or to material accumulations of a material with a higher/lower density than that of the material of the rotor. During operation, this rotor rotates about one of its main axes of inertia which does not coincide with the axis of symmetry of the rotor. The rotor has e.g. a circular cylindrical shape into which recesses are machined, which cause asymmetry. Due to the fact that the main axis of inertia, about which the rotor rotates, does not coincide with its contour-related axis of symmetry, the rotor rotating in the stator is also subjected to asymmetry, so that the rotor approaches the (inner) wall of the stator.

The asymmetric place on the lateral surface of the cylindrical body may extend in the axial direction over a partial length or over the total axial length of the cylindrical body.

The asymmetric place on the lateral surface of the cylindrical body is compensated by an appropriate shape of the cylindrical body so that the same is balanced both statically and dynamically when rotating about its main axis of inertia up to its maximum speed.

This shape of the cylindrical body may include recesses and/or protrusions, so that the cylindrical body is balanced both statically and dynamically up to its maximum speed. The protrusions, in particular, may consist of a different material.

In one variant, the electrical machine is a reluctance machine, whose rotor and stator are notched. Other types of travelling field machines may, however, also be employed. The rotor may have thin sheet metal discs with an essentially circular disc shape. The rotor may additionally carry permanent magnets facing the stator.

For the “acceleration” and the “deceleration”, i.e. at low speeds, of the energy storage an emergency running bearing may be provided. This emergency running bearing has a flange which is coupled with bearing, which may be a ball bearing, an anti-friction bearing or the like.

This emergency running bearing is effective only at standstill and low speeds, when the radial position control is not operating, because it works at a minimum speed only. From a minimum speed upwards, e.g. in the range of the nominal speed, the rotor must not be in continuous contact with the emergency running bearing. The emergency running bearing is effective only upon an excessive radial deflection (e.g. upon an excessive external acceleration or impact on the energy storage) as an emergency stop. During operation of the magnetic position control, the rotor shaft correspondingly requires a radial clearance.

The bearing includes a stationary part and a rotatable part with respect to the stator, as well as anti-friction bodies, if required, between the stationary and the rotatable part. The flange may bear against the rotatable part. The flange is formed and dimensioned in such a manner that it clears the rotatable part of the bearing if a predetermined speed is exceeded and below a predetermined speed connects—again—with the rotatable part of the bearing. The rotatable part of the bearing may be a stub shaft which is arranged at the rotor secured against rotation and extends coaxially to the main axis of inertia.

In one variant, the flange may include a tubular portion which is formed and dimensioned in such a manner that it, with the rotor rotating, undergoes a reversible deformation under the influence of a centrifugal force, so that the flange upon exceeding the predetermined speed clears the rotating part of the bearing—e.g. by an expansion in the radial direction—and connects with the rotating part of the bearing below the predetermined speed. The tubular portion may have a closed lateral surface or be provided with slots or other weakening features which are machined in the lateral surface. This causes that the end of the tubular portion which engages/disengages the rotating part of the bearing to expand or to assume its original shape, respectively, at a predetermined speed ranging from approx. 3% to approx. 25% of the operating speed, i.e. approx. several thousands revolutions per minute (e.g. approx. 12,000 to approx. 18,000 revolutions per minute).

In this manner, an emergency running bearing is created as well as ensured that in the lower speed range a means in addition to the electromagnetic suspension is provided by which the position of the rotor relative to the stator is defined.

The presented energy storage is also based on the fact that an asymmetrically formed rotor which rotates about one of its main axes of inertia relative to the stator does not subject its (emergency) bearing which is oriented coaxially to this main axis of inertia with (considerable) radial forces. A rotation obtained in this manner is stable. The shaft flange for the emergency running bearing is aligned coaxially to the main axis of inertia about which the rotor rotates in the stator.

The energy storage is, for example, suitable for an electric motor driven land vehicle for storing the energy which is generated upon a regenerative deceleration by at least one electrical machine in the or at the drive train of the vehicle. In such an arrangement, the energy storage is connected with the electrical machine in the or at the drive train of the vehicle, with the electrical power which is converted in the electrical machine upon deceleration of the vehicle being fed into the energy storage. Thereby, the electrical machine in the energy storage together with the rotating mass associated with the rotor is rotated. The possible operating speeds range from approx. 50,000 to 150,000 revolutions per minute and above.

The rotor of the energy storage, together with at least a portion of the rotating mass, may form a rotating body which comprises an essentially pot-like shape with a bottom part and an essentially annular cylindrical wall portion. The annular cylindrical wall portion may have either an essentially circular cylindrical shape or a polygon-annular shape. The wall portion may, however, be a solid cylinder or a solid polygon, with notches being formed in its outer surface.

The electrical machine may be a (switched) reluctance machine whose rotor and stator are heavily notched. The rotor or the rotating body, respectively, may be formed from sheet metal layers which are axially stacked with respect to its axis of rotation, e.g. from thin (less than 0.5 to 2 mm thick) iron carbide containing sheet metal layers. If a defect occurred (e.g. of the rotor) which would result in the disintegration of the rapidly rotating rotor, the thin sheet metal layers would cause an only limited damage.

Further features, properties, benefits, and possible modifications of this energy storage will become apparent from the following description, in which reference is made to the accompanying drawings.

### SHORT DESCRIPTION OF THE FIGURES

FIG. 1 shows an energy storage in a schematic sectional side view.

FIG. 2a shows the energy storage in a schematic cross-sectional view in a first design variant.

FIG. 2b shows the rotor of the energy storage in a schematic perspective view in a second design variant.

FIG. 3 is a schematic illustration of a control circuit.

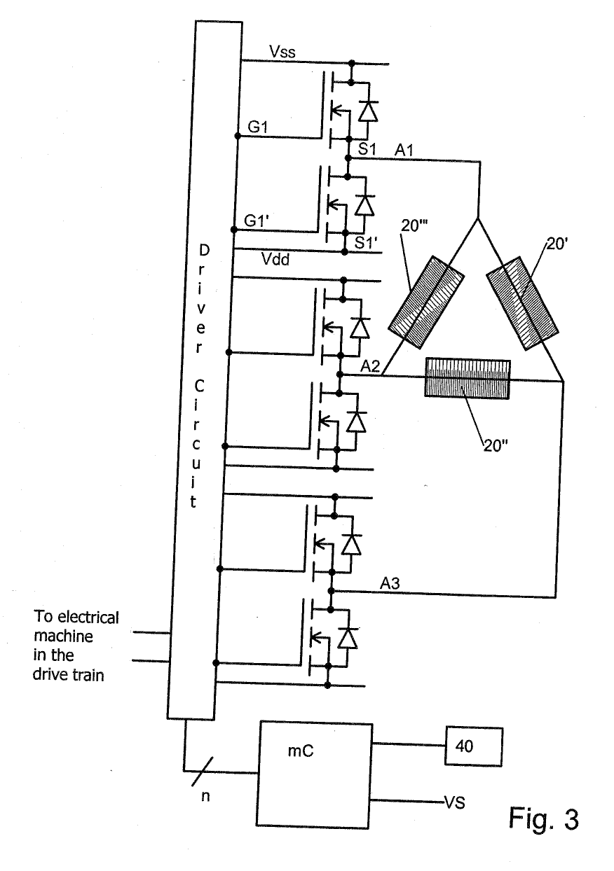

FIG. 4 shows a drive train of a motor vehicle with the energy storage in a schematic illustration.

### DETAILED DESCRIPTION OF EMBODIMENTS OF THE ENERGY STORAGE

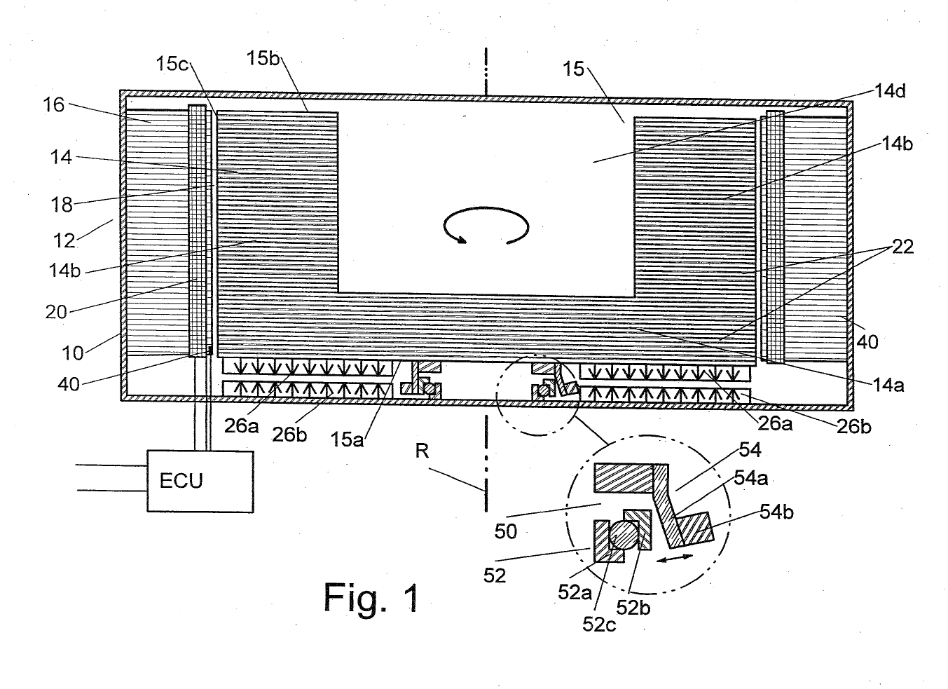

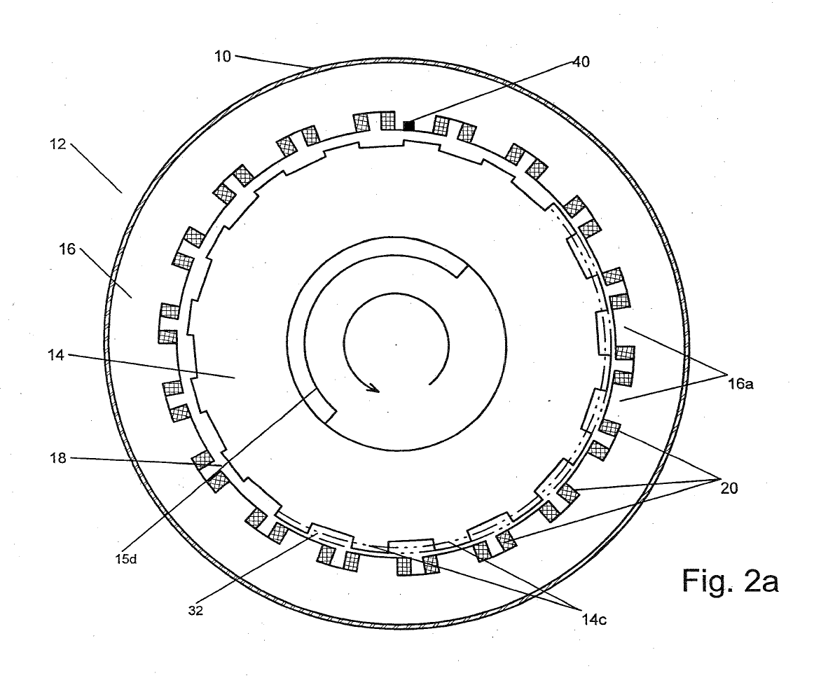

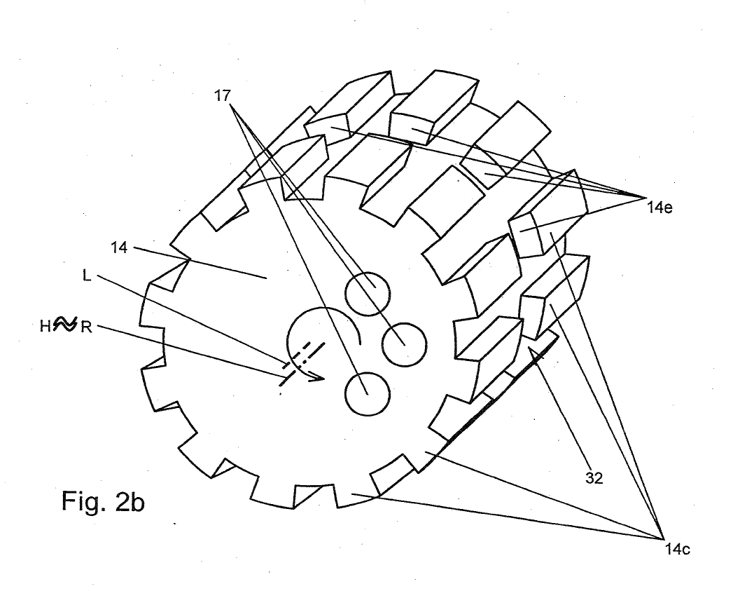

FIGS. 1 and 2 show an energy storage which is arranged in a closed circular cylindrical and thrust-resistant housing 10. The housing 10 accommodates an electrical machine 12 in the form of a reluctance machine with a rotor 14 and a stator 16. Details of the reluctance machine will be explained later. The stator 16 is separated from the rotor 14 by an air gap 18 and has a plurality of stator coils 20 which are associated to one stator tooth 16a each. The rotor 14 is surrounded by the stator 16 and has an essentially pot-like shape with a bottom part 14a and an essentially annular cylindrical wall portion 14b. The rotor 14 is further associated with a rotating mass 22 as a constructional unit which, which together with the rotor 14, forms a rotating cylindrical body 15. In the illustrated example, this rotating mass 22 is formed in such a manner that the bottom part 14a and the annular cylindrical wall portion 14b are made from significantly more material than would be required for the functioning of the electrical machine 12. In other word, the rotor 14 is ‘thicker’ both in the radial and the axial direction (i.e. comprises more material) than would be required for electric/magnetic reasons.

The rotor 14 and the rotating mass 22 are formed in a constructional unit from a stack of thin iron sheet metal discs 30. These iron sheet metal discs 30 are stacked above one another to form the cylindrical body 15 comprising the rotor 14 and the rotating mass 22 and, of required, held together by bottom and cover plates (not shown in the figures) of the cylindrical body 15.

The stator 16 and the rotor 14 are notched at their (inner or outer, respectively) respective lateral surfaces facing each other. For this purpose, the stator 16 and the rotor 14 each are provided with an even (but different) number of teeth 16a or 14c, respectively. The coils 20 are disposed exclusively in/on the stator 16 in the form of compact windings. Thus, distinct pole teeth 16a are provided in the stator 16.

The numbers of teeth in the stator 16 and the rotor 14 may be equal, which homogenises the magnetic field and makes the eddy current losses in the stator and the rotor very small. In order to homogenise the torque of the reluctance machine, it is also possible to provide different numbers of teeth in the stator 16 and the rotor 14. For this purpose, a plurality of possible combinations of the stator number of teeth and the rotor number of teeth is available. Herein, a combination of the stator number of teeth higher than or equal to the rotor number of teeth is preferred. The numbers of teeth in the stator may also be a multiple of the number of teeth of the rotor: number of teeth of the stator=number of teeth of the rotor*number of phases of the stator*number of notches per pole and phase. This applies for the formation of a travelling field winding in the stator, which homogenises the magnetic field.

With a rotation movement of the rotors 14, the self-inductivity of a stator coil 20 changes periodically between a minimum value and a maximum value. The torque at the rotor is proportional to the square of the current through the stator coils 20 proportional, i.e. the direction of the torque is independent on the direction of the current in the stator coils 20. The sign of the torque is dependent on the sign of the inductivity change with the rotor 14 rotating. At an increasing inductivity, a positive torque (motor mode) is generated, and at decreasing inductivity, a negative torque (generator mode) is generated. A great change in the inductivity as a function of the rotor position causes a high torque.

The reluctance machine is suited for a highly efficient energy conversion over a wide speed range. The rotor 14 may economically be manufactured in relatively few manufacturing steps. The stator 16 has marked poles 16a at which compact stator coils 20 are arranged. The stator coils 20 may either be slipped-on as formed coils or made in a direct winding method. The heat loss generated in the stator 16 may easily be dissipated to the outside via the stator and the housing to cooling fins (not shown).

This electrical machine comprises a very simply constructed robust rotor which, in addition, is designed in such a manner that it causes low magnetic losses. With a machine of this type, very high speeds (up to 150,000 revolutions per minute and above) may be achieved. Another aspect is the electric/magnetic excitability of the reluctance machine. This is of importance for the storage capability of the energy at low (e.g. magnetic) losses.

The cylindrical body 15 has two end faces 15a, 15b and a lateral surface 15c. In the area of the bottom end face 15a in the installed position of the energy storage (FIG. 1 bottom) permanent magnets 26a are arranged at the cylindrical body 15. Opposite these permanent magnets 26a stationary permanent magnets 26b of the same polarity are arranged at the bottom of the housing 10, in order to keep the cylindrical body 15 at a distance relative to the stationary permanent magnets. For this purpose, the corresponding permanent magnets 26a, 26b in the area of the end face 15a or at the bottom of the housing 10, respectively, are arranged in such a manner that they repel each other. As can be seen from FIG. 1, the permanent magnets 26a, 26b are oriented with their pole faces transversely to the axis of rotation of the cylindrical body 15. The permanent magnets 26a attached at the cylindrical body 15 are arranged along the circumference—in FIG. 1 the bottom—of the end face 15a. They have end faces or pole faces with a certain polarity (N or S), which are oriented to repelling areas of stationary permanent magnets with identical polarity (N or S). Thereby, the rotating cylindrical body 15 is kept at a contactless distance from the den stationary permanent magnet/s or in an axial direction, respectively. Thereby, a suspension of the rotating cylindrical body 15 in the direction along its axis of rotation R is achieved.

In addition, the cylindrical body 15 in the illustrated variant of the energy storage comprises a radially oriented asymmetric place 32 in the area of the lateral surface which faces the air gap 18. This is indicated in FIG. 2a by the chain-two-dot enveloped area within which the teeth 14c of the rotor are radially more protruding than along the remaining circumference of lateral surface of the cylindrical body 15, which faces the air gap 18. Depending on where the asymmetric place 32 of the rotor 14 is positioned, the air gap 18 is correspondingly smaller in the radial direction.

The asymmetric place 32 at the lateral surface 15c of the cylindrical body 15 in the variant of the energy storage illustrated in FIG. 2a is an area which protrudes in the radial direction relative to the remaining lateral surface 15c with a circumferential angle approx. half the total circumference of the cylindrical body 15. It may, however, also assume approx. one fourth to three fourths of the total circumference of the cylindrical body 15.

In the variant of the energy storage of FIG. 2a, the asymmetric place 32 at the lateral surface 15c of the cylindrical body 15 protrudes in the radial direction relative to the remaining lateral surface by approx. 50% of the radial dimension of the air gap and extends in the axial direction over the total axial length of the cylindrical body.

In a variant shown in FIG. 2b, the cylindrical body 15 with the rotor 14 has an essentially circular (solid) cylindrical shape. The cylindrical body 15 has a longitudinal centre axis L which differs from a main axis of inertia H of the circular cylindrical body 15. The main axis of inertia H of the cylindrical body 15 is offset relative to the longitudinal centre axis L towards one or several circular recesses 17. The recesses 17 extend parallel to the longitudinal centre axis L. During rotation of the cylindrical body 15 the same rotates about the main axis of inertia H; the axis of rotation R therefore also coincides at least approximately with the main axis of inertia H of the rotor or of the cylindrical body 15, respectively. The emergency running bearing which will be described later is also aligned with the main axis of inertia H of the cylindrical body 15.

The asymmetric place at lateral surface of the cylindrical body is compensated by the shape of the cylindrical body in such a manner that the same is both statically and dynamically balanced up to its maximum speed. For this purpose, a semicircular protrusion 15d is provided at the inner wall of the rotor 14 in the illustrated variant of the energy storage.

The radially oriented asymmetric place 32 at lateral surface 15c of the cylindrical body 15, which faces the air gap 18 causes an air gap 18 with variable widths in the radial direction along the circumference of the rotor. A result of the various magnetic conditions along the circumference is that upon rotation of the cylindrical body 15 the same approaches the stator 16. By a corresponding selective modification of the magnetic field of the stator coil 20 this tendency may be counteracted so that the rotor 14 attempts to assume or maintains a concentric position relative to the stator 16. This is achieved by a control circuit ECU which is connected with the stator coil.

This control circuit comprises a processor μC with a driver circuit, which is programmed in such a manner that it determines the switching behaviour of one or two half-bridges which are formed by series-connected semiconductor switches S1, S1′ . . . for each of the stator coils 20′, 20″, 20′″ dependent on an external signal VS which specifies the motor or generator mode of the energy storage. The control circuit thereby embosses an electromagnetic rotating field which rotates the rotor 14 in the motor mode of the energy storage by means of consumed electrical power of the or of each stator coil 20 from the electrical machine in the drive train of the motor vehicle via lines A1, A2, A3. In the generator mode of the energy storage, it withdraws electrical power from the or from each stator coil 20′, 20″, 20′″ according to an electromagnetic rotating field which is induced by the rotating rotor 14 and feeds it into the driver circuit via lines Vdd and Vss. The electrical power is made available to the electrical machine in the drive train of the motor vehicle.

Furthermore, the control circuit ECU is adapted to vary the electrical rotating field as a function of the spatial position of the asymmetric place 32 of the cylindrical body 15 relative to the stator 16 in such a manner that the centre of gravity of the cylindrical body 15 is urged towards its axis of rotation R and the main axis of inertia of the cylindrical body is urged towards its axis of rotation R.

For this purpose, the control circuit ECU is connected with a contactlessly operating sensor 40 for sensing the spatial position of the asymmetric place 32 relative to the stator 16 during rotation of the rotor 14.

The sensor 40 which is a Hall sensor in the present variant and whose only function is the determination of the position of the asymmetric place along the circumference of the rotor, senses the points of time in the control circuit ECU, in which the leading and the trailing contour of the asymmetric place 32 of the cylindrical body 15 passes the sensor 40. From the time difference between two of these points of time following each other, the processor μC in the control circuit ECU may determine the circumferential speed and, based on the known diameter of the cylindrical body 15, its current angular velocity.

The asymmetric place 32 of the cylindrical body 15 which is oriented to the air gap and faces the (inner) wall of the stator 16 has the tendency to approach the stator 16 during rotation of the cylindrical body. This is due to different magnetic conditions which are prevailing along the circumference of the rotor 14 because of the varying width of the air gap. By a selective modification of the current through the stator coil(s) and thus of the magnetic field of the stator coil, this tendency may be counteracted in such a manner that the rotor together with the cylindrical body attempts to assume or maintains a concentric position relative to the stator. For this purpose, the stator coil is connected with a control circuit. This control circuit changes or modulates the amplitude of the stator coil current in synchronism with the speed of the rotor. The control circuit has a means for determining the angular position of the rotor, both during the rotary drive and the deceleration of the rotor for a phase-correct output of the amplitude of the stator coil current. It is thereby possible to generate the radial force which is required for the correction of the position of the rotor relative to the stator. The rotor angular position is to be determined via a sensor which is connected with the control circuit or by the reaction of the rotor on the currents and/or voltages of the stator windings.

The control circuit is additionally connected with sensors, e.g. Hall sensors, for sensing the spatial position of the asymmetric place relative to the stator. Thereby, the control circuit receives sensor signals which reflect the current radial position of the rotor or its axis of rotation within the stator for determining the actual value.

In order to cause the cylindrical body to return into its central position during rotation, a correction signal is superimposed on the current through the coil(s), whose distribution (amplitude and phase, if required) as a function of the angular position of the rotor relative to the stator as well as of the position of the rotor relative to the stator in two dimensions (in the plane transversely to the axis of rotation R) is defined in such a manner that the incorrect position of the rotor relative to the stator is compensated. The desired nominal position of the rotor is the geometric locus in which the axis of rotation and thus the main axis of inertia of the rotor have the maximum distance from the stator. In other words, the regulation of the coil current with the superimposed correction signal causes the rotor—in spite of its asymmetry—to be separated from the stator by an air gap whose width is sufficiently large to ensure that the rotor does not collide with the stator. This regulating operation is performed continuously.

For a better stabilisation of the cylindrical body 15 relative to the stator in the axial direction, the inner or outer surfaces of the rotor or of the stator, respectively, which face each other may also comprise one or several axially spaced (continuous) recesses 14e or protrusions which are oriented in the circumferential direction. These recesses and protrusions at the stator are shaped complementary to the recesses and protrusions at the rotor so that they are in alignment with each other.

The energy storage also comprises an emergency running bearing 50. This emergency running bearing 50 has an essentially tubular flange 54 which is coupled with a bearing 52 which is a ball bearing herein.

The bearing 52 comprises an annular part 52a and an annular part 52b which are arranged stationary or rotatable, respectively, with respect to the stator 16 and the bottom of the housing 10, respectively. The rotatable annular part 52b surrounds the stationary annular part 52a forming a circular race for friction bodies 52c, e.g. ceramic balls, which are housed between these two parts 52a, 52b. The tubular flange 54 is attached with one end—in FIG. 1 the upper end—at the bottom side of the rotor 14 secured against rotation, for example by means of welding. In the neutral condition of the energy storage, i.e. with the rotor 14 not or only slightly rotating, the flange 54 with its free other end—in FIG. 1 the lower end—bears against the rotatable part 52a of the bearing. Upon exceeding a predetermined speed, the flange with its free end clears the rotatable annular part 52b of the bearing and below a predetermined speed connects (again) with the rotatable part 52b of the bearing. While the annular part 52b of the bearing is not in engagement with the flange 54, the above described magnetic suspension of the permanent magnets 26a, 26b, on the one hand, and/or the suspension caused by the cooperation of the control circuit ECU with the asymmetric place 32, on the other hand, take over the guidance of the cylindrical body 15.

The flange 54 has a tubular free portion 54a which, with the rotor rotating, undergoes a reversible deformation under the influence of a centrifugal force, so that the flange upon exceeding the predetermined speed clears the rotating part of the bearing and below the predetermined speed connects with the rotating part of the bearing. The tubular portion 54a has a lateral surface into which slots (not illustrated) are machined. The free end is enclosed by an annular collar 54b. Together with the slots, this causes in a defined manner that the end of the tubular portion 54a which engages/disengages the rotating part 52b of the bearing 52 expands or assumes its original shape again, respectively, at a predetermined speed ranging from 10% to approx. 15% of the operating speed, i.e. approx. several thousands revolutions per minute.

In the above described variant, the stator is provided with a coil set which extends over its axial length. It is, however, also possible to extend the stator and the rotor in the axial direction so that two or three coil sets may be arranged in the axial direction along the circumference. Each of these two or three coil sets may be controlled separately by the ECU. In this case, the asymmetric place may be “divided” so that it is divided into two or three portions in the axial direction, which are offset by 180° or 120°, respectively, in the circumferential direction. Due to the ECU-controlled independent but matched control of the coil sets for compensating the tilting or tumbling movements of the rotor, this enables a particularly smooth running and precise orientation of the cylindrical body 15 in the stator 16.

The energy storage is suited e.g. for an electric motor driven land vehicle with at least one electrical machine in the or at the drive train of the vehicle for storing the energy which is generated upon a regenerative deceleration. In such an arrangement, the energy storage is connected with the electrical machine in the or at the drive train of the vehicle, with the electrical power which is converted in the electrical machine upon deceleration of the vehicle being fed into the energy storage. Thereby, the electrical machine in the energy storage together with the rotating mass associated with the rotor is rotated. The possible operating speeds range from approx. 50,000 to 150,000 revolutions per minute and above.

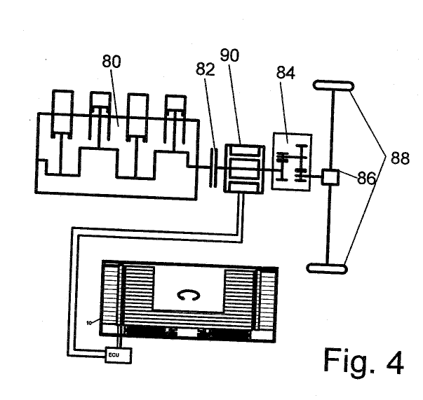

In the motor mode or charging mode of the energy storage (see FIG. 4), the stator coils 20 of the energy storage—controlled by an electronic power reversing unit ECU—are supplied with electrical current which is taken from an electrical machine 90 in the drive train of the motor vehicle (combustion machine 80, clutch 82, gearbox 84, differential 86, wheels 88). This electrical machine 90 operates in the generator mode and decelerates the motor vehicle. This causes the rotor 14 together with the rotating mass 22 of the energy storage to rotate.

In the generator mode, the rotor is decelerated by the stator field, and the stator coils 20 of the energy storage provide electrical energy. This electrical energy—controlled by the electronic power reversing unit ECU—is fed into the electrical machine 90 disposed in the drive train of the motor vehicle. This electrical machine 90 then operates in the motor mode and drives the motor vehicle.

It is understood that the above specified ranges also cover all intermediate values. The proportions and dimensions illustrated in the figures may differ in real implementations because individual aspects are shown over-dimensioned/over-proportional for the sake of an enhanced clearness, while details with minor relevance for comprehension are shown smaller or not at all. It is also intended that individual aspects which are described in the context of one embodiment may be transferred to another one; for example, the notch-shaped recesses or protrusions, respectively, provided in the circumferential direction at the stator and the rotor of one variant may also be employed in the other variants.

1. An energy storage, comprising
an electrical machine with a rotor and a stator, wherein
the stator
is separated from the rotor by an air gap, and comprises
at least one stator coil which during operation interacts with the rotor via a rotating field, and wherein
the rotor
surrounds the stator and is adapted to rotate about the stator, or is surrounded by the stator and is adapted to rotate in the stator about an axis of rotation (R),
is provided with a rotating mass with which is forms a cylindrical body with two end faces and one lateral surface, and the rotor
comprising at least one permanent magnet in the area of at least one of the end faces, which corresponds with at least one stationary permanent magnet of identical polarity in order to keep the cylindrical body at a distance from the stationary permanent magnet, and/or
a main axis of inertia (H) which at least approximately coincides with the axis of rotation (R) and having a non-rotation symmetrical shape in a sectional plane which extends transversely to the main axis of inertia (H).

2. The energy storage according to claim 1, wherein the stator coil is to be connected with a control circuit (ECU) which is adapted to emboss an electromagnetic rotating field on the rotor in the motor mode, causing is to rotate by means of the electrical power consumption of the or of each stator coil, and in the generator mode, to supply current to the stator coils of the energy storage in such a manner that the rotating field of the stator decelerates the rotor with its rotating mass against its rotation motion and that electrical power is taken from the energy storage.

3. The energy storage according to claim 2, wherein the control circuit (ECU) is to be connected with a sensor for sensing the spatial position of an asymmetric place relative to the stator during rotation of the rotor.

4. The energy storage according to claim 1, wherein the control circuit is to be connected with one or several sensors for sensing the spatial position of the axis of rotation of the rotor in two dimensions relative to the stator.

5. The energy storage according to claim 3, wherein the control circuit (ECU) is adapted to vary the electrical rotating field as a function of a spatial position of the asymmetric place of the cylindrical body relative to the stator in such a manner that the centre of gravity of the cylindrical body is urged towards its axis of rotation (R) and that the main axis of inertia of the cylindrical body coincides with its axis of rotation (R).

6. The energy storage according to claim 3, wherein the asymmetric place at the lateral surface of the cylindrical body is an area which is protruding or recessed in the radial direction relative to the remaining lateral surface with a circumferential angle of approx. 25% up to approx. 75% of the total circumference, e.g. approx. 50%.

7. The energy storage according to claim 3, wherein die asymmetric place at the lateral surface of the cylindrical body is protruding or recessed in the radial direction relative to the remaining lateral surface by approx. 5% to approx. 75% of the radial dimension of the air gap.

8. The energy storage according to claim 3, wherein die asymmetric place at the lateral surface of the cylindrical body extends in the axial direction over a portion or the total axial length of the cylindrical body.

9. The energy storage according to claim 3, wherein die asymmetric place at the lateral surface of the cylindrical body is compensated by the form of the cylindrical body in such a manner that the cylindrical body is balanced both statically and dynamically up to its maximum speed, with the cylindrical body comprising a stub shaft which extends coaxially to the main axis of inertia.

10. The energy storage according to claim 9, wherein the shape of the cylindrical body comprises recesses and/or protrusions, so that the cylindrical body is balanced both statically and dynamically up to its maximum speed, with the cylindrical body comprising a stub shaft which extends coaxially to the main axis of inertia.

11. The energy storage according to claim 1, wherein die electrical machine is a reluctance machine whose rotor and stator are notched orthogonally to the direction of rotation.

12. The energy storage according to claim 1, wherein the rotor and the stator comprise one or several complementarily formed recesses or protrusions which extend in the direction of rotation at their inner or outer surface, respectively, facing each other.

13. The energy storage according to claim 1, wherein the rotor comprises thin metallic sheet metal discs which have an essentially circular disc shape.

14. The energy storage according to claim 1, wherein
the rotor comprises a flange which is coupled with a bearing, and wherein
the bearing comprises a part and a part, respectively, which is stationary or rotating, respectively, relative to the stator, with the flange bearing against the rotating part and being shaped and dimensioned in such a manner that it clears the rotating part of the bearing upon exceeding a predetermined speed and connects with the rotating part of the bearing below a predetermined speed.

15. The energy storage according to claim 14, wherein the flange comprises a tubular portion which is shaped and dimensioned in such a manner that it undergoes a reversible deformation under the influence of a centrifugal force so that it clears the rotating part of the bearing upon exceeding a predetermined speed and connects with the rotating part of the bearing below a predetermined speed.

16. A method for operating an energy storage with the features and properties
according to claim 1, comprising the steps:
sensing the current position of the axis of rotation of the rotor relative to the stator,
determining the position of the asymmetric place along the circumference of the cylindrical body relative to the stator,
determining the change of the magnetic field and comparing same with the distribution of the magnetic field over time without a spatial approach, in order to determine whether and how far the rotor approaches the stator in the area of the asymmetric place,
changing the distribution of the currents flowing through the stator coil in such a manner that an incorrect position of the rotor relative to the stator is compensated as a function of the angular position of the rotor relative to the stator as well as of the position of the rotor relative to the stator in two dimensions, with the nominal position of the rotor being defined as the geometric locus in which the axis of rotation and thus the main axis of inertia of the rotor has the maximum distance form the stator.

17. The method for operating an energy storage according to claim 16, wherein a directed radial force is generated by a speed synchronous modulation of the amplitude of the stator coil current, whose direction is determined by the phase position of the modulation of the stator coil current, and whose amount is determined by the amplitude of the modulation in such a manner that the rotor is urged towards its centred nominal position.
